(19) United States
(12) Patent Application Publication
(10) Pub. No.: US 2012/0166831 A1
(43) Pub. Date: Jun. 28, 2012

(54) SYSTEM FOR CONTROLLING POWER CONSUMPTION OF SEMICONDUCTOR INTEGRATED CIRCUIT

(75) Inventor: Masashi Shimoda, Chiba-ken (JP)

(73) Assignee: KABUSHIKI KAISHA TOSHIBA, Tokyo (JP)

(21) Appl. No.: 13/236,013

(22) Filed: Sep. 19, 2011

(30) Foreign Application Priority Data
Dec. 24, 2010 (JP) 2010-286840

(51) Int. Cl. G06F 1/32

(52) U.S. Cl. 713/320

(57) ABSTRACT

According to one embodiment, a semiconductor integrated circuit has peripheral devices and a clock supply control circuit which controls supply of clock signals to the devices. An operating system for controlling execution of tasks includes a task information registration unit, a dispatcher, a semaphore managing unit, and a power consumption managing unit. The task information registration unit registers peripheral device use information as task information. The dispatcher controls start of any one of the tasks when an execution request of the task is received and to control switching task execution. The semaphore managing unit to manage state of acquisition and store semaphores. The power consumption managing unit refers to the peripheral device use information and the semaphores, and issues a request to the clock supply control circuit so as to supply or stop the clock signal, in accordance with execution states of the tasks and acquisition state of the semaphores.

The application is based upon and claims the benefit of priority from the prior Japanese Patent Application No. 2010-286840, filed on Dec. 24, 2010, the entire contents of which are incorporated herein by reference.

### FIELD

Embodiments described herein relate generally to a system for controlling power consumption of a semiconductor integrated circuit.

### BACKGROUND

Integration of a semiconductor integrated circuit has been progressed, and a semiconductor integrated circuit with peripheral devices such as a LCD controller, a JPEG processing module and a timer respectively arranged around a CPU core is practically used. Using such a semiconductor integrated circuit, a system working with an operating system is known. In that system, the operating system controls operation of a peripheral device under execution of a task. Such a large-scaled semiconductor integrated circuit involves a problem of how power consumption is reduced.

Conventionally, in order to reduce power consumption of the CPU core, the operation of the CPU is shifted to a standby-mode of a low voltage operation when the CPU becomes a state that any task to be executed by the operating system is not present. Further, in order to reduce power consumption of a peripheral device, a clock gating technique or a power cutting technique is used. According to the clock gating technique, a clock signal is supplied only when the peripheral device is scheduled to be used. According to the power cutting technique, the peripheral device is connected to a power source only when the peripheral device is scheduled to be used.

The clock gating technique involves a problem that a waiting time up to becoming actually possible to use the peripheral device arises when supply of the clock signal is started after receiving a use request for the peripheral device. In order to solve such a problem, conventionally, a task list is prepared for managing an execution state and an execution priority of a plurality of tasks in the operating system. When a task which is necessary to use the peripheral device is set in an executable state in the operating system, supply of the clock signal is started to the peripheral device so that the waiting time up to becoming actually possible to use the peripheral device is reduced.

However, such a task list is difficult to be prepared in a system such as an embedded system in which a task state is frequently changed by an external event. Thus, the above clock gating technique may not serve effectively. Further, a task switch may occur during use of a peripheral device, and the foregoing task enters into a waiting state. In this case, mechanism of maintaining supply of the clock signal to the peripheral device bound to the task in the waiting state is not present so that processing by the peripheral device is stopped, and data obtained by the processing becomes invalid.

### BRIEF DESCRIPTION OF THE DRAWINGS

FIG. 1 is a block diagram showing a power consumption control system according to a first embodiment.

FIG. 2 is a flow chart showing an example of a flow of processing in a system of the first embodiment.

FIG. 3 is a view, showing an example of peripheral device use information which is used in the system of the first embodiment.

FIG. 4 is a time chart showing an example of a control of supplying a clock signal in the system of the first embodiment.

FIG. 5 is a block diagram showing a power consumption control system according to a second embodiment.

FIG. 6 is a view showing an example of a management table which is used in the system of the second embodiment.

FIG. 7 is a flow chart showing an example of a flow of processing of the system of the second embodiment.

FIG. 8 is a time chart showing an example of a control of supplying a clock signal in the system of the second embodiment.

FIG. 9 is a block diagram showing a power consumption control system according to a third embodiment.

FIG. 10 is a flow chart showing an example of a flow of processing of the system of the third embodiment.

FIG. 11 is a time chart showing an example including controls of supplying power and supplying a clock signal in the system of the third embodiment.

FIG. 12 is a block diagram showing a power consumption control system according to a fourth embodiment.

FIG. 13 is a flow chart showing an example of processing of the system of the fourth embodiment.

### DETAILED DESCRIPTION

According to one embodiment, a system of controlling power consumption of a semiconductor integrated circuit is presented. The system is provided with a plurality of peripheral devices and a clock supply control circuit to control supply of a clock signal to the peripheral devices. Execution of a plurality of tasks for the peripheral devices is controlled by an operating system.

The operating system includes a task information registration unit, a dispatcher, a semaphore managing unit, and a power consumption managing. The task information registration unit registers peripheral device use information for each of the tasks. The peripheral device use information shows use or non-use of the peripheral devices as task information. The dispatcher controls start of any of the tasks when an execution request of the task is received, and controls switching task execution among the tasks. The semaphore managing unit to manage state of acquisition and store semaphores indicating acquisition state of acquiring rights to use the peripheral devices in the tasks. The power consumption managing unit refers to the peripheral device use information and the semaphores, and issues a request to the clock supply control circuit so as to supply or stop the clock signal, in accordance with execution states of the tasks.

Hereinafter, further embodiments will be described with reference to the drawings.

In the drawings, the same reference numerals denote the same or similar portions respectively.

A first embodiment will be described below. A power consumption control system of the embodiment controls power consumption of a semiconductor integrated circuit is provided with a plurality of peripheral devices and clock supply control circuits that control supply of clock signals to the peripheral devices. Execution of tasks for the peripheral devices is controlled by an operating system.

The above operating system controls the clock supply control circuits so as to reduce the power consumption of the peripheral devices.

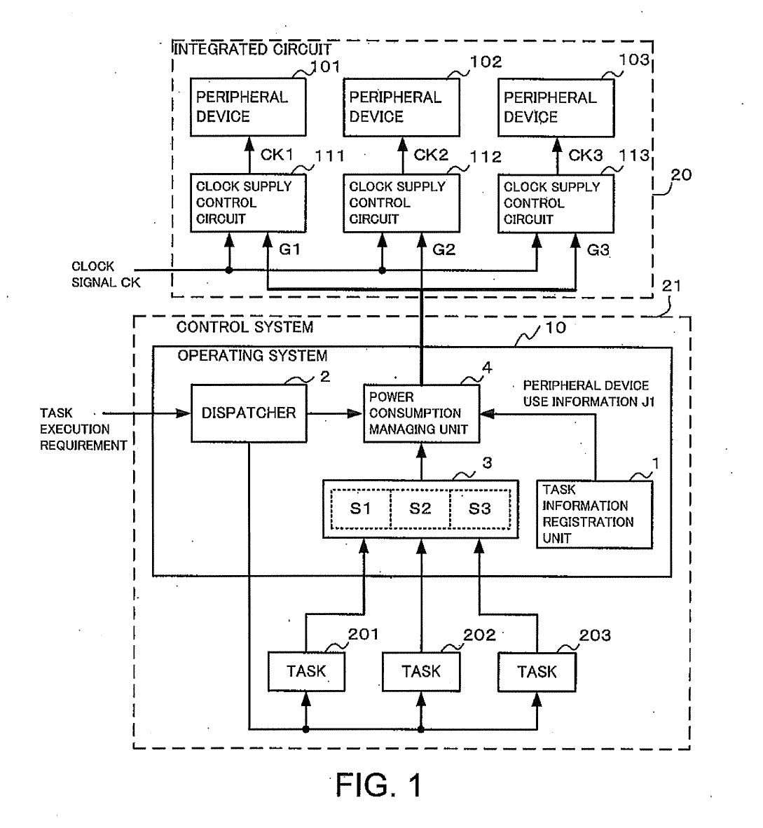

FIG. 1 is a block diagram showing a power consumption control system according to a first embodiment.

In the system of FIG. 1, power consumption of a semiconductor integrated circuit 20 is controlled. The semiconductor integrated circuit 20 is provided with three peripheral devices 101 to 103 and three clock supply control circuits 111 to 113. In the case, three tasks 201 to 203 are executed, for example. However, the numbers of peripheral devices, clock supply control circuits and tasks are not limited to those shown above.

A control system 21 has a CPU, a memory etc. as hardware. An operating system 10 is installed in the control system 21, and the control system 21 includes tasks 201 to 203 as programs. The hardware such as the CPU and the memory may be provided to the inside of the semiconductor integrated circuit together with the peripheral devices and the clock supply control circuits.

The operating system 10 is provided with a task information registration unit 1, a dispatcher 2, a semaphore managing unit 3, and a power consumption managing unit 4. The task information registration unit 1 registers peripheral device use information showing use or non-use of the peripheral devices 101 to 103 by the tasks 201 to 203 respectively, as one of pieces of task information. The dispatcher 2 controls start of the tasks 201 to 203 when a task execution request is received from the outside of the operating system 10. The dispatcher 2 controls switching of execution among tasks 201 to 203. The semaphore managing unit 3 stores states of acquiring rights to use the peripheral devices 101 to 103. The power consumption managing unit 4 controls the clock supply control circuits 111 to 113 which supply clock signals CK1 to CK3 to the peripheral devices 101 to 103.

The peripheral device use information registered in the task information registration unit 1 indicates whether or not the tasks 201 to 203 use the peripheral devices 101 to 103, as one of pieces of necessary information for initial registration of the tasks 201 to 203. The peripheral device use information has bit data showing use or non-use of the peripheral devices 101 to 103. A bit value “1” shows “use” of the corresponding peripheral device. A bit value “0” shows “non-use” of the corresponding peripheral device.

The dispatcher 2 operates repeatedly and determines a task to be executed next, every time a dispatch occurs. By the function, a new task is started when each task execution request is received, or an execution task is switched among already started plural tasks.

The semaphore managing unit 3 stores semaphores S1 to S3 showing the states of acquiring the rights to use the peripheral devices 101 to 103 respectively. Prior to using the peripheral devices 101 to 103, each of the tasks 201 to 203 issues a semaphore acquisition request corresponding to the peripheral devices to the semaphore managing unit 3 according to the peripheral device use information. Each of the tasks 201 to 203 actually acquires the requested semaphore as it is released, and executes the processing of each corresponding peripheral devices from 101 to 103. On the other hand, when the corresponding semaphore is acquired by another task, processing execution of the corresponding peripheral device is waited until the semaphore is released. After the processing of the corresponding peripheral device is ended, the semaphore is released through interruption, and the operation system 10 transmits the release of the semaphore to a task which waits for the release of the semaphore.

The power consumption managing unit 4 determines whether or not the clock signal CK may be supplied to the peripheral devices 101 to 103 respectively, with reference to the peripheral device use information registered in the task information registration unit 1 and with reference to the semaphores S1 to S3, according to execution state of the tasks controlled by dispatcher 2. Further, the power consumption managing unit 4 outputs clock control signals G1 to G3, and manages the clock supply control circuits 111 to 113 so as to supply or stop the clock signal CK.

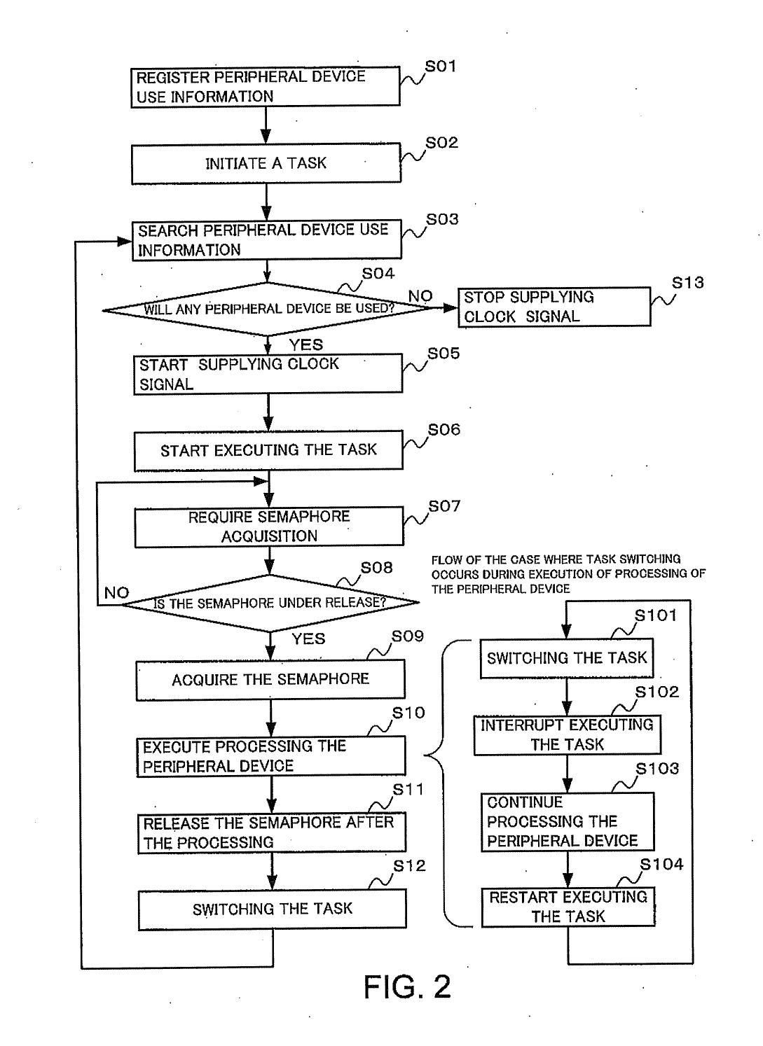

A flow of the processing of the power consumption control in the system of the embodiment will be described using a flowchart shown in FIG. 2.

The task information registration unit 1 registers a peripheral device use information of each task (step S01).

Then, when the semiconductor integrated circuit 20 is operated and the operating system 10 receives a task execution request, a task corresponding to the execution request is started under control of the dispatcher 2 (step S02).

After start of the task, when the task transits to an execution state, the power consumption managing unit 4 searches peripheral device use information stored in the task information registration unit 1 (step S03). Then, the power consumption managing unit 4 checks which one of the peripheral devices 101 to 103 is to be used by the task, and obtains peripheral device use information J1 (step S04).

Based on the check, the power consumption managing unit 4 issues a request to the clock supply control circuit for the peripheral device not to be used by the task in order to stop supply of the clock signal CK. Further, the power consumption managing unit 4 issues a request to the clock supply control circuit for the peripheral device to be used by the task in order to start supply of the clock signal CK (step S05).

Then, execution of the task is started (step S06), and the task under execution issues a semaphore acquisition request to the semaphore managing unit 3, prior to using the peripheral device (step S07).

At this time, the operating system 10 checks releasing state of the semaphore which is requested for acquisition (step S08). The task is set in a waiting state until the semaphore is released, when the semaphore is not released. The task acquires the semaphore when the semaphore is released (step S09). The task executes the processing of the peripheral device after acquisition of the semaphore (step S10).

When the processing of the peripheral device is executed, a task switching is caused by the dispatcher 2 in some cases. In the cases, according to the embodiment, the flow shown from steps S101 to step S104 is executed.

Specifically, for example, a task switching arises when the processing of the peripheral device is executed (step S101). The task under execution waives its right to execution and interrupts the processing, in order to wait for the processing of the peripheral device executed by the task (step S102). The task under execution is sometimes deprived of the right to execution by a higher priority task operated by an external event. However, the task is still in a state of acquiring the semaphore. Thus, supply of the clock signal CK to the corresponding peripheral device is continued, and the processing of the peripheral device is continued (step S103). Then, a task switching is caused again when the execution of the higher priority task is slept or when a notification of an event is issued at the time of end of the execution of the peripheral devices, and the execution of the task is restarted (step S104).

Further, when the task switching is performed, the flow shown from step S101 to step S104 are repeated.

Then, when the processing of the peripheral devices is ended, the task releases the corresponding semaphore (step S11).

A task switching may be performed during the released state of the semaphore (step S12). In the case, the power consumption managing unit 4 checks the peripheral device use information of the peripheral device of the task to be executed. When supply of the clock signal CK is judged to be unnecessary to be continued, the power consumption managing unit 4 issues a request to the following clock supply control circuit to cut supply of the clock signal CK (step S13). The clock supply control circuit is a circuit which supplies the clock signal CK to the corresponding peripheral device.

Accordingly, in the processing of the flow shown in FIG. 2, the clock signal CK is supplied only to the peripheral device which is used by the task, and the clock signal CK to the peripheral device which is not used by the task is cut. Thus, the power consumption caused by the clock signal supplying operation can be reduced. On the other hand, since supply of the clock signal CK to the peripheral device is continued so long as the semaphore is acquired, even when task executed is switched to another task, the processing of the peripheral device can be continued. As a result, parallel execution of the processing of the task executed after the task switching and the processing of the peripheral device is allowed so that an effective power supply management can be realized.

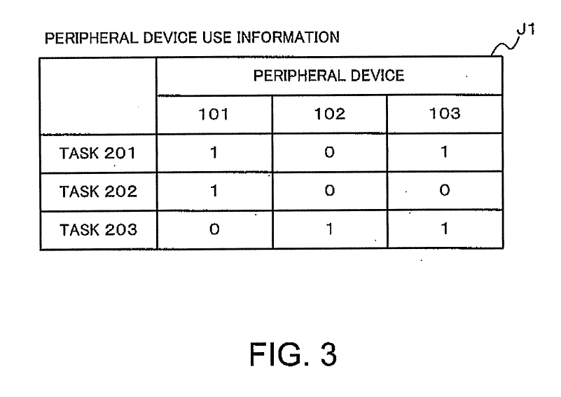

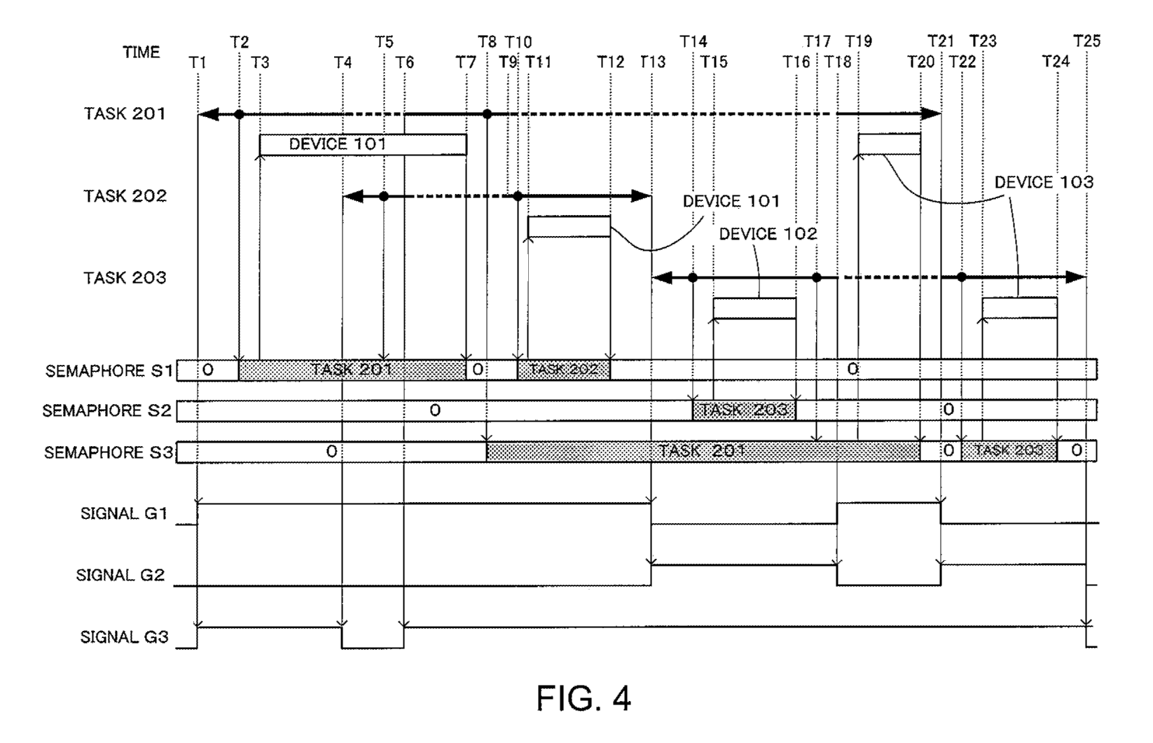

A detailed example of controlling supply of clock signals CK1 to CK3 associated with task switching will be described with reference to FIG. 3 and FIG. 4.

FIG. 3 shows an example of a table of the peripheral device use information registered in the task information registration unit 1. In the example shown in FIG. 3, a task 201 uses the peripheral devices 101, 103, a task 202 uses the peripheral device 101, and a task 203 uses the peripheral devices 102, 103.

FIG. 4 shows a time chart showing a state of controlling supply of the clock signals to the peripheral devices 101 to 103 when the tasks 201 to 203 are executed. In the case of FIG. 4, the peripheral device use information shown in FIG. 3 is registered in the task information registration unit 1. The times T1 to T25 indicated in FIG. 4 shows either one of a time when a task is started by the operation of the dispatcher 2, a time when a task is switched by the operation of the dispatcher 2, or a time when a semaphore acquisition request is transmitted for one of the peripheral devices 101 to 103. With respect to the clock control signals G1 to G3 of FIG. 4, a high level (hereinafter referred to as “H” level) shows supply of the clock signal CK, and a low level (hereinafter referred to as “L”) shows stop of the clock signal CK.

In the example of FIG. 4, the task 201 is started at time T1. At this time point, the semaphores S1 to S3 are released.

The power consumption managing unit 4 searches the peripheral device use information, and obtains peripheral device use information J1 of the task 201. The semaphores S1, S3 corresponding to the peripheral devices 101, 103 to be used by the task 201 are released, and accordingly the power consumption managing unit 4 sets the clock control signals G1, G3 to “H” level, and issues a request to the clock supply control circuits 111, 113 so as to supply the clock signals CK1 to CK3. In response to the request, the clock signal control circuits 111, 113 start supply the clock signals to the peripheral devices 101, 103, and execution of the task 201 is started.

Further, at time T2, the task 201 transmits a semaphore acquisition request to the semaphore managing unit 3. At this time, since the semaphore S1 is set in a released state which is shown as “0” in FIG. 4, the task 201 acquires the semaphore S1. Then, the semaphore S1 is set in an acquisition state which is shown as “1” in FIG. 4.

Subsequently, at time T3, the task 201 starts processing of the peripheral device 101. Then, at time T4, a task switching is performed; and the task 202 is started. Accordingly, the semaphore managing unit 3 stops the execution of the task 201, while continuing the processing of the peripheral device 101.

At this time, the power consumption managing unit 4 confirms the state of the semaphore S1. Since the semaphore S1 is set in an acquisition state, the supply of the clock signal CK1 to the peripheral device 101 is continued. Continuation of the processing of the peripheral device 101 by the task 201 and execution of the task 202 are effectively realized.

Further, at time T4, since the task 202 is started, the power consumption managing unit 4 searches the peripheral device use information, and checks the peripheral device to be used by the task 202. In the example, the peripheral device 101 is used by the task 202. However, the clock signal CK1 is already supplied to the peripheral device 101, and accordingly the supply of the clock signal is continued as it is. On the other hand, the peripheral device 103 is not to be used by the task 202, and accordingly the power consumption unit 4 sets the clock control signal G3 to “L” level, and issues a request to the peripheral device 103 so as to stop supply of the clock signal CK.

Then, at time T5, the acquisition request for the semaphore S1 is issued by the task 202. However, at this time, since the semaphore S1 is set in an acquisition state by the task 201, the task 202 can not acquire the semaphore S1, and waits for the release of the semaphore S1.

At time T6, the task executed is switched to the task 201. At this time, the power consumption managing unit 4 sets the clock control signal G3 to “H” level, and start supply of the corresponding clock signal CK3 to the peripheral device 103 used by the task 201. The task 201 restarts the execution after the clock signal CK3 is started to be supplied to the peripheral device 103.

At time T7, when the processing of the peripheral device 101 is ended, the semaphore S1 is released through the interruption processing.

Subsequently, at time T8, the task 201 transmits an acquisition request for the semaphore S3. At this time, since the semaphore S3 is set in ae released state, the task 201 acquires the semaphore S3.

At time T9, the task is switched to the task 202. The task 202 is a task using the peripheral device 101, and accordingly the power consumption managing unit 4 continues the supply of the clock signal CK1 to the peripheral device 101. However, the semaphore S3 is set in an acquisition state, and accordingly the power consumption managing unit 4 similarly issues a request to the peripheral device 103 so as to continue the supply of the clock signal CK3.

The task 202, which restarts the execution of the task at time T9, issues an acquisition request for the semaphore S1 at time T10. At this time, since the semaphore S1 is set in the released state, the task 201 acquires the semaphore S1, and at time T11, the task 201 starts the processing of the peripheral device 101.

Then, at time T12, when the processing of the peripheral device 101 is ended, the operating system 10 is notified of the release of the semaphore S1 through an interruption processing in response to the ending. Thus, the semaphore S1 is set in a released state.

Then, at time T13, a task switching is performed so as to end the task 202 and to start the task 203. Then, the power consumption managing unit 4 confirms the state of the semaphore S1. Since the semaphore S1 is set in a released state, the power consumption managing unit 4 sets the clock control signal G1 to “L” level, and transmits an request to the clock supply control circuit 111 so as to stop the supply of the clock signal CK. In response to the request, the clock supply control circuit 111 stops the supply of the clock signal CK to the peripheral device 101.

Further, at time T13, the task 203 is started, and accordingly the power consumption managing unit 4 searches the peripheral device use information, and checks the peripheral device to be used by the task 203. In the example, the task 203 uses the peripheral devices 102, 103. The clock signal CK3 is already supplied to the peripheral device 103, and accordingly the power consumption managing unit 4 sets the clock control signal G2 to H″ level and issues a request to the clock supply control circuit 112 so as to supply the clock signal CK2. In response to the request, the clock supply control circuit 112 starts supply of the clock signal CK2 to the peripheral device 102.

Subsequently, at time T14, the task 203 transmits an acquisition request for the semaphore S2 to the semaphore managing unit 3. At this time, since the semaphore S2 is set in the released state, the task 203 acquires the semaphore S2. The task 203 starts the processing of the peripheral device 102 at time T15. Then, at time T16, when the processing of the peripheral device 102 is ended, the operating system 10 is notified of release of the semaphore S2 by the task 203 through an interruption processing. Thus, the semaphore S2 is set in a released state.

Then, at time T17, the task 203 transmits an acquisition request for the semaphore S3. However, at this time, since the semaphore S3 is set in the acquisition state by the task 201, the task 203 can not acquire the semaphore S3 and waits for release of the semaphore S3.

At time T18, the task is switched to the task 201. The power consumption managing unit 4 searches the peripheral device use information, and transmits a request to the peripheral devices to be used by the task 201 so as to supply the clock signals. At this time, the clock signal CK3 is already supplied to the peripheral device 103, and accordingly the power consumption managing unit 4 sets the clock control signal G1 to “H” level, and issues a request to the clock supply control circuit 111 so as to start the supply of the clock signal CK1.

The power consumption managing unit 4 confirms the state of the semaphore S2. Since the semaphore S2 is set in the released state, the power consumption managing unit 4 sets the clock control signal G2 to “L” level, and issues a request to the clock supply control circuit 112 so as to stop the supply of the clock signal CK. In response to the instruction, the clock supply control circuit 112 stops supply of the clock signal CK2 to the peripheral device 102.

The task 201, which restarts execution of the task at time T18, starts the processing of the peripheral device 103 at time T19. Then, at time T20, when the processing of the peripheral device 103 is ended, the operating system 10 is notified of release of the semaphore S3 through interruption processing in response to the ending. Thus, the semaphore S3 is set in a released state.

Then, at time T21, a task switching is performed so as to end the task 201 and to restart the task 203. The task 203 is a task using the peripheral device 103, and accordingly the power consumption managing unit 4 continues the supply of the clock signal CK3 to the peripheral device 103. Further, the power consumption managing unit 4 confirms the state of the semaphore S1. Since the semaphore S1 is set in the released state, the power consumption managing unit 4 sets the clock control signal G1 at “L” level, and issues a request to the clock supply control circuit 111 so as to stop supply of the clock signal CK1. Further, the power consumption managing unit 4 changes the clock control signal G2 to “H” level, and issues a request of starting the supply of the clock signal CK2 to the peripheral device 102 to be used by the task 203.

The task 203, which restarts the execution of the task at time T21, transmits an acquisition request for the semaphore S3 at time T22. At this time, since the semaphore S3 is set in the released state, the task 203 acquires the semaphore S3, and starts the processing of the peripheral device 103 at time T23.

Then, at time T24, when the processing of the peripheral device 103 is ended, the operating system 10 is notified of release of the semaphore S3 through an interruption processing in response to the ending. Thus, the semaphore S3 is set in a released state.

Then, at time T25, the task 203 is ended. Accordingly, the power consumption managing unit 4 confirms the state of the semaphores S2 and S3. Since both of the semaphores S2 and S3 are set in the released state, the power consumption managing unit 4 sets the clock control signals G2 and G3 to “L” level, and issues requests to the clock supply control circuits 112 and 113, to stop the supply of the clock signal CK. In response to the instruction, the clock supply control circuits 112, 113 stop the supply of the clock signal CK to the peripheral devices 102, 103, respectively.

According to the embodiment, the operating system 10 registers the peripheral device use information in the task information registration unit 1 as one of the task information, when the corresponding task is registered. When the task is started, the peripheral device use information is searched, and the clock signal CK is supplied only to at least one of the peripheral devices to be used by the task. On the other hand, the clock signal CK is paused to be the supplied to the peripheral device not to be used by the task. Thus, the power consumption can be reduced during clock operation. Further, the operating system 10 reduces unnecessary power consumption as described above, but continuously supplies the clock signal CK to at least one of the peripheral devices so long as the corresponding at least one of the semaphores is acquired. Accordingly, the processing of the peripheral devices is not stopped, even when an interruption of the processing occurs due to a task switching. Thus, reduction of a processing efficiency of the peripheral devices can be prevented.

In the first embodiment, supply of the clock signal CK is started when a task is started and it is after the start of task that a peripheral devices is used. Thus, the processing can be prepared using a sufficient time, even in a case of utilizing a peripheral device with long starting time which ranges from starting of supply of the clock signal CK to becoming possible to start the processing. On the other hand, when a long waiting time arises due to a task switching after start of a task, extra waiting power may be consumed, while some peripheral devices may have a short starting time. In such peripheral devices having a short starting time, preparation for the processing is ready in time, even when supply of the clock signal CK is started at the time of acquiring the semaphore. The following embodiment provides a power consumption control system which can cause different timings of start of supply of the clock signal CK according to the amount of the starting time of a peripheral device i.e. long or short, or the amount of a waiting power i.e. large or small.

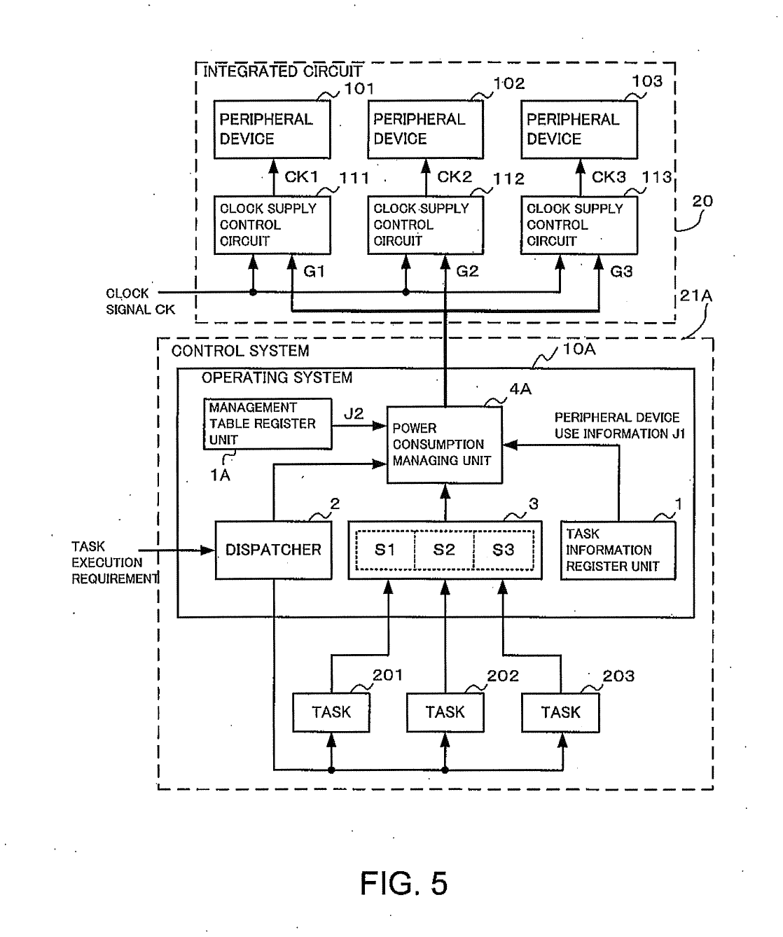

FIG. 5 is a block diagram showing the power consumption control system according to a second embodiment. Similarly to the first embodiment, the second embodiment shows a case where tasks 201 to 203 are executed in a control system 21A. The control system 21A controls power consumption of a semiconductor integrated circuit 20 provided with peripheral devices 101 to 103 and clock supply control circuits 111 to 113.

In addition to the structure of the first embodiment of FIG. 1, an operating system 10A of the embodiment is provided with a management table registration unit 1A. The management table registration unit 1A stores a management table showing whether start of supply of a clock signal CK to each peripheral device is to be performed when a task is started, or when a semaphore S1, S2 or S3 is acquired.

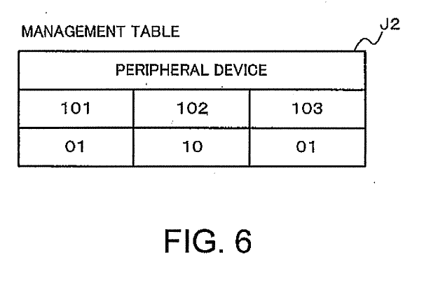

FIG. 6 shows an example of the management table stored in the management table registration unit 1A. In the second embodiment shown in FIG. 6, the value “10” indicates start of supplying a clock signal CK when a task is started, and the value “01” indicates start of supplying the clock signal CK when a semaphore is acquired. The management table of FIG. 6 shows a start of supplying the clock signal CK to the peripheral device 102 when a task is started, and shows a start of supplying the clock signal CK to the peripheral devices 101, 103 when a semaphore is acquired.

In the operating system 10A of the embodiment, a power consumption managing unit 4A controls supply of the clock signal CK to the peripheral devices 101 to 103, based on peripheral device use information J1 and management table information J2. The peripheral device use information J1 shows use of a peripheral device.

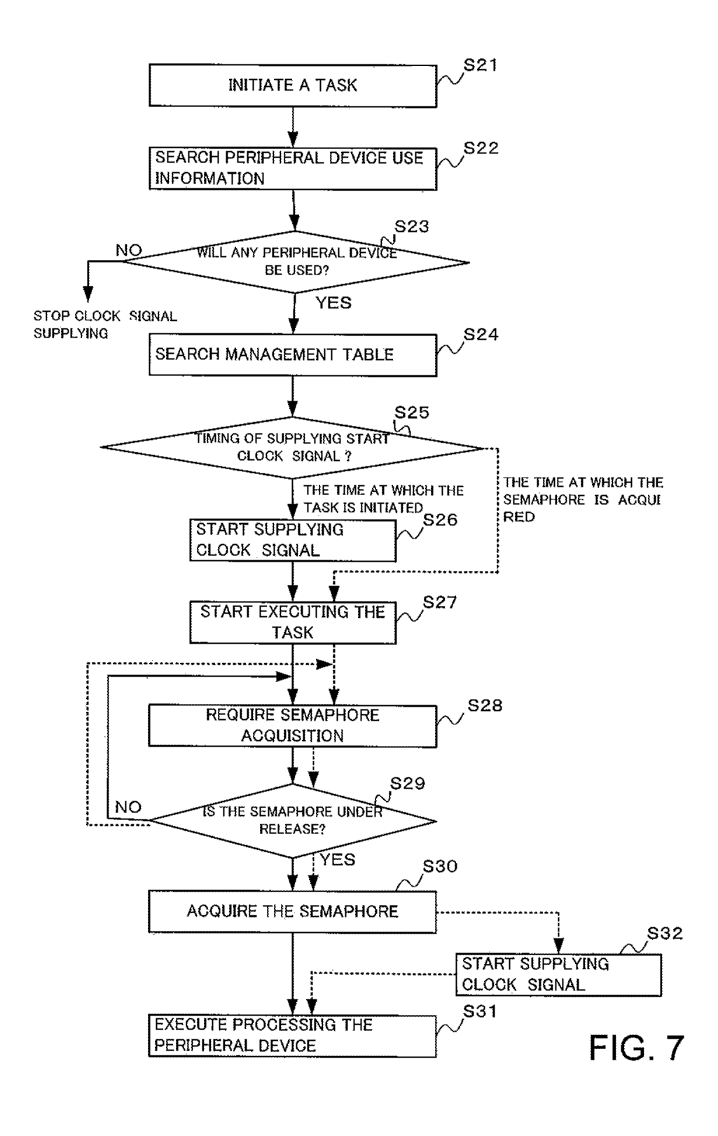

A flow of the processing of power consumption control according to the second embodiment will be described based on a flowchart shown in FIG. 7.

In the second embodiment, similarly to the first embodiment, a task is started (step S21). When the task is started, the peripheral device use information is searched by a power consumption managing unit 4A. (step S22). The power consumption managing unit 4A checks which one of the peripheral devices 101 to 103 is to be used by the task (step S23).

Based on the check, the power consumption managing unit 4A issues a request to one of the clock supply control circuits 111 to 113 for controlling the peripheral device not to be used by the task, so as to stop supply of the clock signal CK.

On the other hand, the power consumption managing unit 4A performs search of the information J2 regarding one of the peripheral devices to be used, from the management table stored in the management table registration unit 1A (step S24). The power consumption managing unit 4A checks whether start of supply of the clock signal needs to be performed at the timing when a task is started, or at the timing when a semaphore is acquired (step S25).

In the second embodiment, the subsequent flows are different depending on a result of the check. When the timing of start of supply of the clock signal CK is a timing of start of a task, step S25 and the following steps are performed by a flow shown by a solid line. When the timing of start of supply of the clock signal CK is a timing of acquisition of a semaphore, step S25 and the following steps are performed by a flow shown by a dotted line. The flow shown by the solid line is the same as that of the first embodiment.

On the other hand, in the case following the flow shown by the dotted line, the started task starts execution (step S27). Prior to using a peripheral device, a semaphore acquisition request is issued to the operating system 10A (step S28).

At this time, in a semaphore managing unit 3, whether or not the requested semaphore is released is shown (step S29). When the requested semaphore is not released, the task repeats the semaphore acquisition request, and when the requested semaphore is released, the task acquires the semaphore (step S30).

In response to the acquisition of the semaphore, the power consumption managing unit 4A issued a request to one of the clock supply control circuits for controlling the corresponding peripheral device that acquires the semaphore, so as to start supplying the clock signal CK (step S32).

Then, the task executes processing of the peripheral device (step S31). The processing after step 31 is similar to the processing of the first embodiment.

According to the processing following the above described flow, the search of the management table is performed for the peripheral device to be used by a task, and it is determined whether supply of the clock signal CK is started when the task is started, or when the semaphore for the peripheral device is acquired. Thus, the power consumption of the peripheral device can be reduced when supply of the clock signal is started at the timing that the semaphore is acquired for the peripheral device.

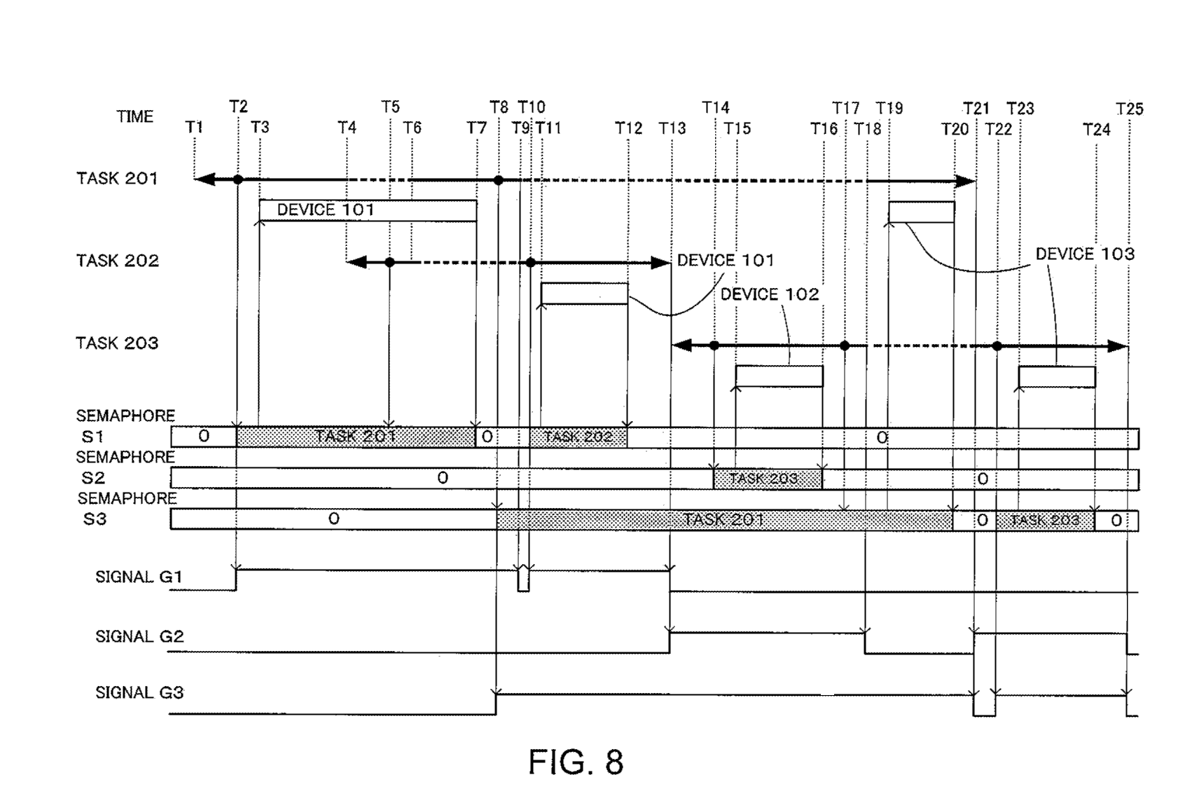

FIG. 8 shows a detailed example of controlling supply of a clock signal CK when a task switching is performed with reference to the peripheral device use information shown in FIG. 3 and the management table shown in FIG. 6. The operation of the example at the time of the task switching is similar to the example shown in FIG. 4. The timings of start of supply of the clock signal CK to the peripheral devices will be described in comparison with FIG. 4.

In the management table of FIG. 6, the information for the peripheral device 102 is described as “10” so that the clock signal CK is started to be supplied to the device 102 when a task is started. Similarly to FIG. 4, the clock control signal G2 is changed to “H” level at time T13 when a task 203 is started.

On the other hand, in the management of the table of FIG. 6, the information for the peripheral device 102 is described as “01” so that supply of the clock signal CK is started when a semaphore is acquired. Accordingly, the clock control signal G1 is changed to “H” level, as shown in FIG. 8, at time T2 when a semaphore S1 is acquired, while the clock control signal G1 is changed to “H” level, as shown in FIG. 4, at time T1 when the task 201 is started.

Further, at time T7, when the processing of the peripheral device 101 is ended and the semaphore S1 is released, the clock control signal G1 is changed to “L” level at time T9 when a task switching is performed. Then, when the task 202 acquires the semaphore 51 at time T10, the clock control signal G1 is changed to “H” level again.

Similarly, in the management table of FIG. 6, the information for the peripheral device 103 is described as “01” so that supply of the clock signal is started when a semaphore is acquired. Accordingly, the clock control signal G3 is changed to “H” level, as shown in FIG. 8, at time T8 when the semaphore S3 is acquired, while the clock control signal G3 is changed to “H” level, as shown in FIG. 4, at time T1 when the task 201 is started.

Further, when the processing of the peripheral device 103 is ended at time T20 and the semaphore S3 is released, the clock control signal G3 is changed to “L” level at time T21 when the task switching is performed. Then, when the task 202 acquires the semaphore S3 at time T22, the clock control signal G3 is changed to “H” level again.

According to the second embodiment, the management table may designate whether the timing of start of supply of the clock signal to a peripheral device is controlled to coincide with the start of a task, or to coincide with the acquisition of a semaphore. For example, in a peripheral device with short starting time, or in a peripheral device with large standby power, the standby power of the peripheral device can be reduced by designating the timing of start of supply of the clock signal which coincides with the timing of acquiring the semaphore.

In recent years, with lowering of a driving voltage of a semiconductor integrated circuit, threshold values of transistors composing the semiconductor integrated circuit tends to be low, and the leak current tends to increase. As one of the techniques for preventing increase of power consumption due to leak current, a technique of stopping supply of a power to a non-operated circuit block is used. The following embodiment provides a power consumption control system for a semiconductor integrated circuit having peripheral devices and power supply control circuits.

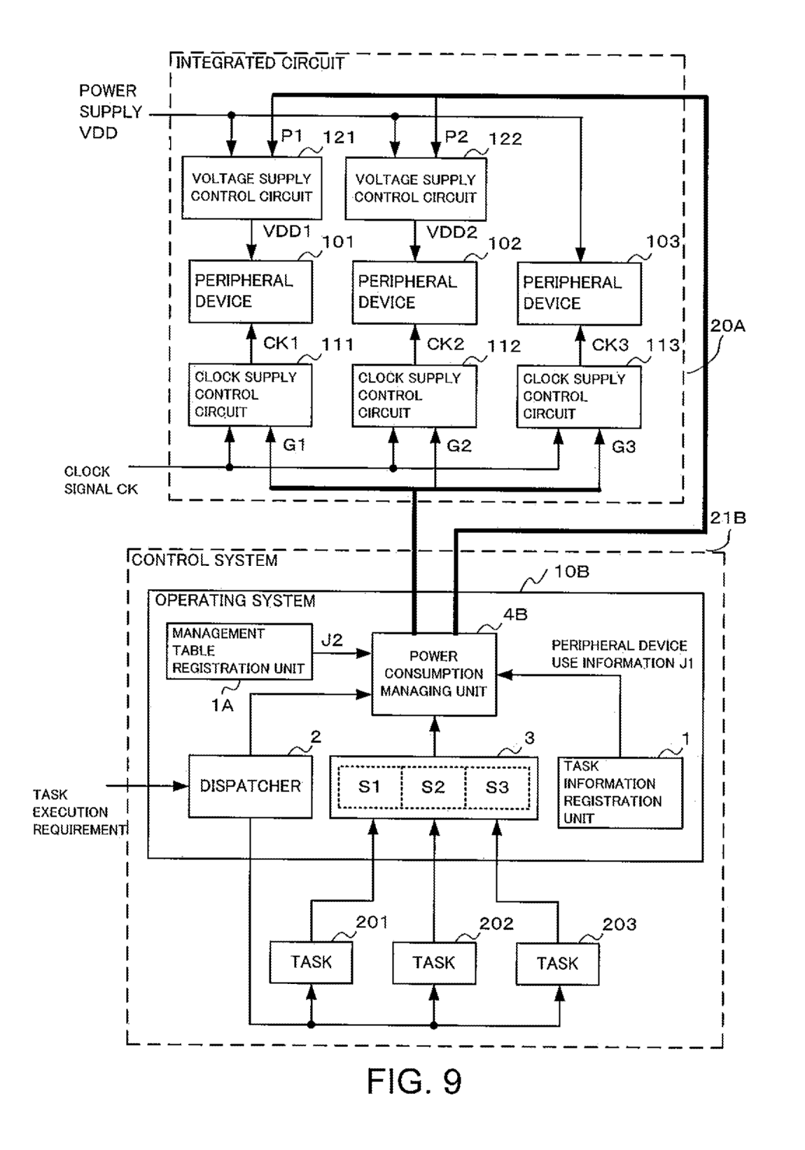

FIG. 9 is a block diagram showing the power consumption control system according to a third embodiment of the invention. In a semiconductor integrated circuit 20A shown in FIG. 9, power supply control circuits 121, 122 are connected to the peripheral devices 101, 102. Power supply VDD is normally supplied to a peripheral device 103 in order to correspond to interrupt processing, etc.

A structure of an operating system 10B which is provided in a control system 21B of the embodiment is basically same as that of the operating system 10A of the second embodiment. A difference from the operating system 10A is that a power consumption managing unit 4B of the embodiment outputs clock control signals G1 to G3 to the clock supply control circuits 111 to 113 and that the power consumption managing unit 4B further outputs power supply control signals P1, P2 to the power supply control circuits 121, 122. The power supply control circuits 121, 122 provide supply voltages VDD, VDD2 to the peripheral devices 101, 102, respectively.

Control of the output of the clock control signals G1 to G3 from the power consumption managing unit 4B is the same as that of the power consumption managing unit 4A of the second embodiment. The processing of outputting the power supply control signals P1, P2 will be described.

The power consumption managing unit 4B performs processing of outputting the power supply control signals P1, P2 as follows. When a task is started, the power consumption managing unit 4B searches peripheral device information stored in a task information registration unit 1, and checks whether or not the task is necessary to use the peripheral device 101 or 102 which needs power supply control. When the started task is found to use either of the peripheral devices 101, 102, the power consumption managing unit 4B checks information J2 of a management table stored in a management table registration unit 1A, subsequently.

As described in the second embodiment, the starting time of supply of the clock signal CK to the peripheral devices is defined in the management table registration unit 1A, and the definition is also used to define the starting time of providing power supply. The power consumption managing unit 4B determines, based on the information J2 obtained from the management table registration unit 1A, whether the timing of start of power supply to at least one of the peripheral devices is set to coincide with the timing of starting the task, or to coincide with the timing of acquiring a semaphore.

The power consumption managing unit 4B transmits the power supply control signals P1, P2 to the power supply control circuits 121, 122 at the determined power supply start timing. The power supply control signals P1, P2 contain respective instructions for starting supply of power. Further, the power consumption managing unit 4B refers to the semaphores of the semaphore managing unit 3, and issues a request to the power supply control circuits 121, 122 so as to continue supply of the power so long as the task acquires the corresponding at least one of the semaphores, and stop power supply when the task is switched after releasing the corresponding at least one of the semaphores.

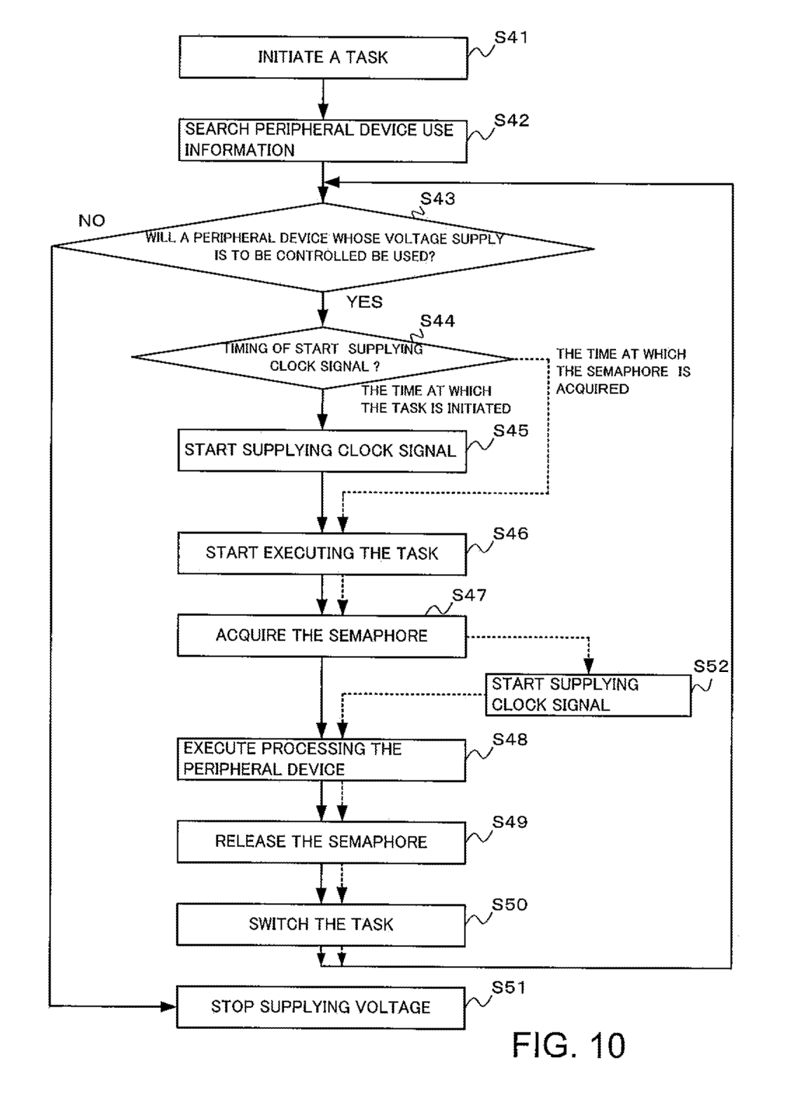

A flow of the processing of power supply control by the system according to the third embodiment will be described using a flowchart shown in FIG. 10.

A task is started (step S41). When the task is started, the power consumption managing unit 4B searches the peripheral device use information of the task information registration unit 1 and obtains the information J1 (step S42), and checks whether the task needs to use the peripheral device 101 or 102 (step S43).

Based on the check, the power consumption managing unit 4B issues a request to at least one of the power supply control circuits for the peripheral device not to be used by the task so as to stop supply of the power (step S51).

On the other hand, for the peripheral device to be used by the task, the information J2 of the management table is obtained with reference to the management table registration unit 1A, and the timing of starting power supply is checked (step S44).

After the step 44, different flows are used depending on the result of the check. Specifically, when the timing of start of supplying power needs to coincide with the timing of start of the task, the steps of the flow shown by a solid line is used, and when the timing of start of supplying power needs to coincide with the timing of acquisition of a semaphore, the steps of the flow shown by a dotted line is used.

When the timing of start of supplying power needs to coincide with the timing of the start of the task, as shown by the flow of the solid line, the power consumption managing unit 4B immediately transmits instructions to the power supply control circuits 121, 122 so as to start supplying power (step S45).

Then, execution of the task is started (step S46). Then, the task under execution acquires at least one of the semaphores (step S47) and executes processing of the corresponding at least one of the peripheral devices (step S48). When the processing is ended, the at least one of the semaphores is released (step S49).

After releasing the at least one of the semaphores, a task switching is performed (step S50). At this time, the power consumption managing unit 4B issues a request to the power supply control circuit for the corresponding peripheral device not to be used by the task so as to stop power supply when the use of the peripheral device by the task is ended (step S51).

On the other hand, when the timing of start of power supply, as shown by the flow of the dotted line, needs to coincide with the timing of acquiring a semaphore, execution of the task is started (step S46). Then, when the task under execution acquires at least one of the semaphore (step S47), the power consumption managing unit 4B issues a request to corresponding one of the power supply control circuits 121, 122 so as to start supplying power (step S52).

In response to the power supply, the processing of the corresponding peripheral device is executed (step S48), and subsequently the step 49 to the step 51 are executed.

In the processing of the above flow, according to the steps S43, S51, power is stopped to be supplied to the peripheral device not to be used by the task out of the peripheral devices 101, 102 whose power supply is controlled when the task is started. Accordingly, leak current is prevented from flowing through the peripheral device not to be used, and further reduction of the power consumption can be achieved.

For the peripheral device to be used by the task, it is changeable according to the information J2 of the management table obtained from the management table registration unit 1A whether the timing of start of power supply is set to coincide with the start of the task or with the timing of acquiring a semaphore. By the function, the power consumption of the peripheral device can be managed more finely.

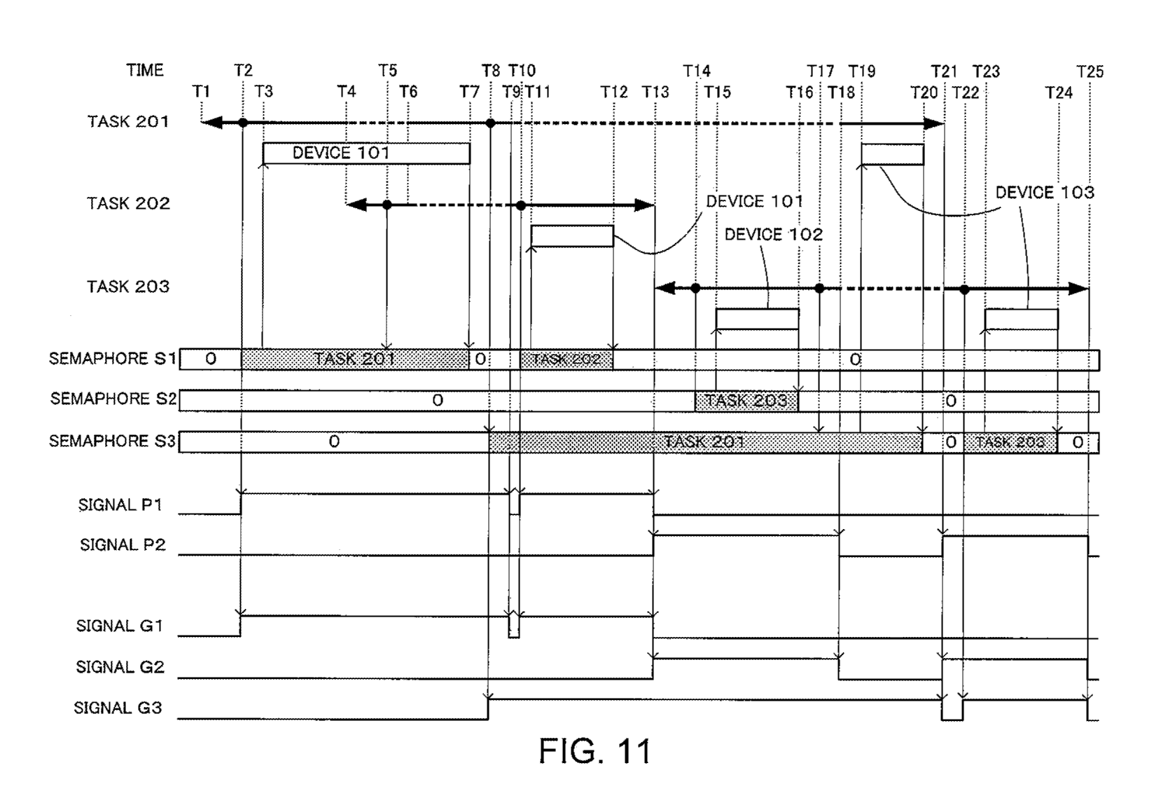

FIG. 11 shows a detailed example of the power supply control and the supply control of the clock signal when a task switching is performed. The task switching and the supply control of the clock signal of the example are similar to that of the example shown in FIG. 8. The power supply control will be described below.

In FIG. 11, when a task 201 is started at time T1, the power consumption managing unit 4B searches the peripheral device use information of the task information registration unit 1, and acquires use information J1 of the task 201. As a result, it is found that the task 201 needs to use the peripheral device 101 which requires power supply control. Accordingly, the power supply managing unit 4B acquires information J2 of the management table with reference to the management table registration unit 1A, and checks the timing of start of power supply to the peripheral device 101.

In the management table shown in FIG. 6, the information J2 of the peripheral device 101 is described as “01” so that the power supply is started when a semaphore S1 is acquired. Accordingly, in order to supply power to the peripheral device 101 at time T2, i.e., when the task 201 acquires the semaphore, the power consumption managing unit 4B sets the power supply control signal P1 to “H” level, and issues a request to the power supply control circuit 121 to supply power. In response to the instruction, the power supply control circuit 121 starts power supply to the peripheral device 101.

Then, at time T7, the use of the peripheral device 101 by the task 201 is ended, and a task switching occurs at time T9. When the task switching is performed, the power consumption managing unit 4 sets the power supply control signal P1 to “L” level, and issues a request to the power supply control circuit 121 so as to stop supplying power to the peripheral device 101.

Then, at time T10, when execution of the started task 202 is started and the semaphore S1 is acquired from the semaphore managing unit 3, the power consumption managing unit 4 starts power supply to the peripheral device 101.

Then, at time T12, the use of the peripheral device 101 by the task 202 is ended, and the semaphore S1 is released. Accordingly, in order to stop power supply to the peripheral device 101 at time T13 when the task switching is performed, the power consumption managing unit 4B sets the power supply control signal P1 to “L” level and issues a request to the power supply control circuit 121 to stop supplying power. In response to the instruction, the power supply control circuit 121 stops power supply to the peripheral device 101.

Further, at time T13, a task 203 is started, and the power consumption managing unit 4B searches the peripheral device use information of the task information registration unit 1 and acquires information J1. As a result, it is found that the task 203 needs to use the peripheral device 102 which requires power supply control. The power consumption managing unit 4B refers to the management table of the management table registration unit 1A, and acquires information J2 of the management table, and checks the timing of start of power supply to the peripheral device 102.

In the management table shown in FIG. 6, the information J2 of the peripheral device 102 is described as “10” so that power supply is started when the task is started. Accordingly, the power consumption managing unit 4B sets the power supply control signal P2 to “H” level at time T13, and issues a request to the power supply control circuit 122 so as to supply power. In response to the instruction, the power supply control circuit 122 starts power supply to the peripheral device 102.

Then, at time T16, the use of the peripheral device 102 by the task 203 is ended, and the corresponding semaphore S2 is released. Accordingly, in order to stop power supply to the peripheral device 102 at time T18 when a task switching is performed, the power consumption managing unit 4B sets the power supply control signal P2 to “L” level and issues a request to the power supply control circuit 122 so as to stop supplying power. In response to the instruction, the power supply control circuit 122 stops power supply to the peripheral device 102.

Then, when the task is switched at time T21 and execution of the task is restarted, the power consumption managing unit 4B sets the power supply control signal P2 to “H” level, and issues a request to the power supply control circuit 122 so as to supply power to the peripheral device 102.

According to the third embodiment, the control of power supply can be performed in addition to the control of supply of the clock signal. Accordingly, the power consumption of the peripheral device can be further reduced.

Since the timing of start of power supply can be set for each peripheral device whose power supply needs to be controlled, the power consumption of the peripheral devices can be managed more finely.

In the aforementioned embodiment, the power consumption of the peripheral device is reduced by the operating system. In the following embodiment, the power consumption of the peripheral device can be reduced without using an operating system for controlling power consumption.

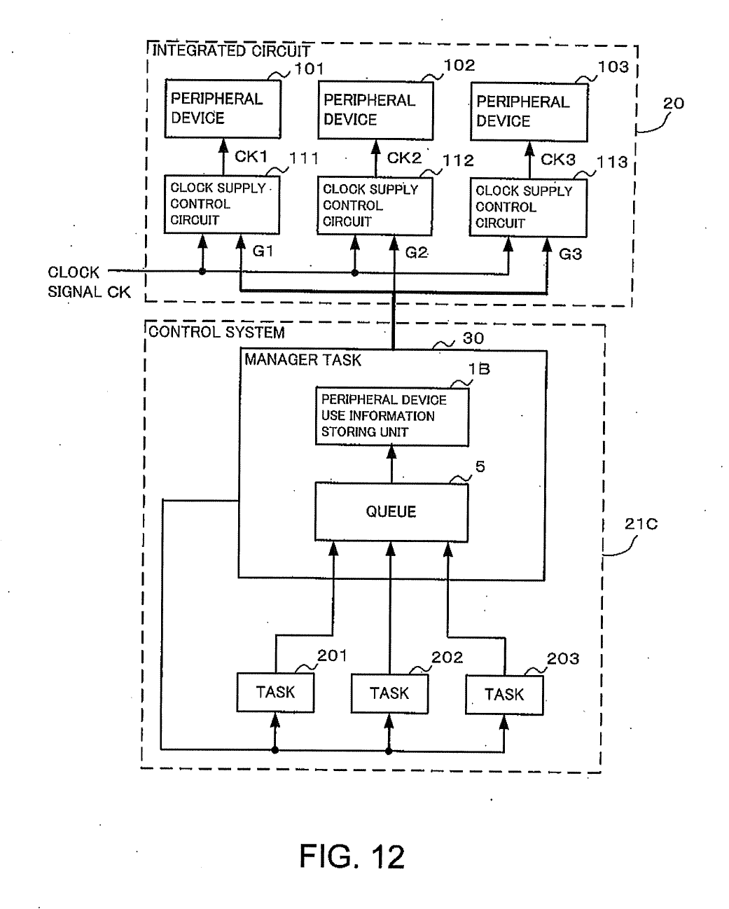

FIG. 12 is a block diagram showing a structure of a power consumption control system according to a fourth embodiment.

According to the fourth embodiment, in a control system 21C, use requests from tasks 201 to 203 which are necessary to use peripheral devices 101 to 103 are received by a manager task 30. The manager task 30 controls use order of each peripheral device, and controls clock supply control circuits 111 to 113.

As shown in FIG. 12, a manager task 20 has a queue 5 and a peripheral device use information storage unit 1B. The peripheral device use information storage unit 1B outputs peripheral device use information J11 which indicates a use schedule of the peripheral devices 101 to 103.

The queue 5 of the manager task 20 receives use requests for the peripheral devices 101 to 103 from the tasks 101 to 103, and the manager task 20 controls use order of the peripheral devices 101 to 103. Further, the manager task 20 updates the peripheral device use information J11 of the peripheral device use information storage unit 1B at the time of queuing or dequeuing from the tasks 101 to 103.

Based on the peripheral device use information J11, the manager task 20 transmits clock control signals G1 to G3 containing instructions to the clock supply control circuits 111 to 113 so as to supply or stop the clock signal CK, respectively.

The manager task 20 transmits the instructions to the clock supply control circuits 111 to 113 so as to supply the clock signal CK respectively, when the peripheral device use information J11 shows “use is scheduled”. The manager task 20 transmits instructions to the clock supply control circuits 111 to 113 so as to stop the clock signal respectively, when the peripheral device use information J11 shows “use is not scheduled”.

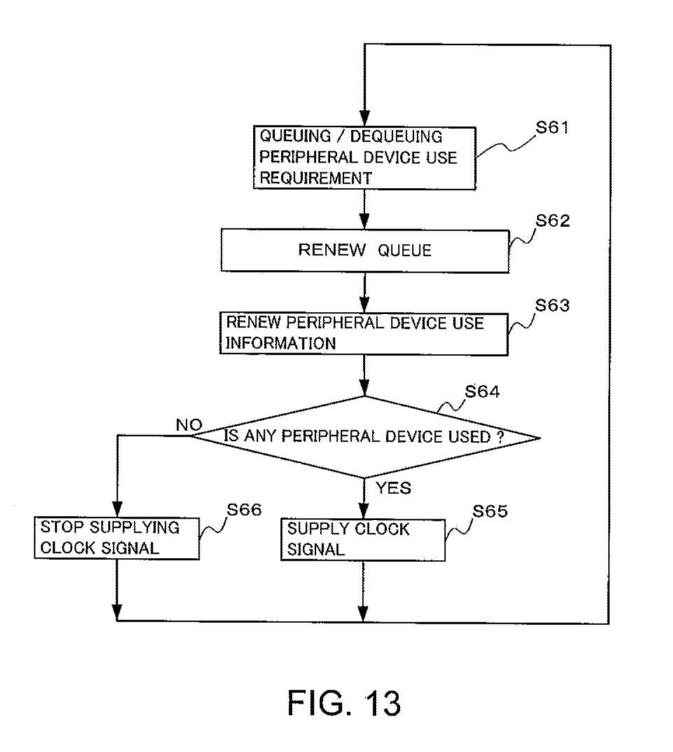

A flow of processing of the power consumption control based on the system of the fourth embodiment will be described using a flowchart shown in FIG. 13.

Queuing or dequeuing of use requests for the peripheral devices 101 to 103 from the tasks 201 to 203 is performed (step S61). Based on the queuing or dequeuing, the manager task 20 updates the queue 5 (step S61). Further, the manager task 20 updates the information J11 stored in the peripheral device use information storage unit 1B (step S63).

Subsequently, the manager task 20 checks the updated peripheral device use information J11 (step S64). When the peripheral device use information J11 shows “use is schedule”, the manager task 20 transmits instructions to the clock supply control circuits 111 to 113 so as to supply the clock signal CK respectively (step S65).

On the other hand, when the peripheral device use information J11 shows “use is not scheduled”, the manager task 20 transmits instructions to the clock supply control circuits 111 to 113 so as to stop the clock signal CK respectively (step S66).

Then, the processing is returned to step S61, and a series of the flows described above is repeatedly executed.

According to the fourth embodiment, the manager task 30 controls power consumption of the peripheral devices. Thus, an operating system for a single purpose of controlling power consumption is not necessary, and even using an operating system for a general purpose of use, the power consumption of the peripheral devices can be reduced.

According to the above embodiments, even when the states of the tasks are frequently changed, the power consumption of the peripheral devices can be reduced without lowering the processing efficiency.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, supply of the clock signal CK to the peripheral devices 102 to 103 may be controlled by one unit of clock supply control circuit which performs control for the peripheral devices. Further, supply of power to the peripheral devices 102 to 103 may be controlled by one unit of power supply control circuit which supplies power to the peripheral devices. A task execution request may be provided from outside of the control systems 21, 21A to 21C, or may be generated inside of the control systems.

What is claimed is:

1. A system of controlling power consumption of a semiconductor integrated circuit, the system being provided with a plurality of peripheral devices and a clock supply control circuit to control supplying a clock signal to the respective peripheral devices, wherein execution of a plurality of tasks for the peripheral devices is controlled by an operating system,
the operating system comprising:
a task information registration unit to register peripheral device use information for each of the tasks, the peripheral device use information showing use or non-use of the peripheral devices as task information;
a dispatcher to control start of any of the tasks when an execution request of the task is received, and to control switching of task execution among the tasks;
a semaphore managing unit to manage state of acquisition and store semaphores indicating acquisition state of acquiring rights to use the peripheral devices by the tasks; and
a power consumption managing unit to refer to the peripheral device use information and the semaphores and to issue a request to the clock supply control circuit so as to supply or stop the clock signal to at least one of the peripheral devices, in accordance with execution states of the tasks.

2. The system according to claim 1, wherein
the power consumption managing unit issues a request to the clock supply control circuit so as to start supplying a clock signal to at least one of the peripheral devices when one of the tasks scheduled to use the peripheral device during release of the corresponding one of the semaphores is started,
the power consumption managing unit issues a request of continuing supply of the clock signal so long as the semaphore is acquired, even if a task switching occurs after the clock signal is started to be supplied, and
the power consumption managing unit further issues a request of stopping supply of the clock signal when a task switching occurs after the semaphore is released.

3. The system according to claim 1, wherein
the operating system further comprises a management table registration unit registering a management table showing whether supply of the clock signal to the at least one of the peripheral devices is started when any one of the tasks is started or when any one of the semaphores is acquired,
the power consumption managing unit determines a timing of start of supplying the clock signal to one of the peripheral devices corresponding to one of the semaphores under release, with reference to the management table, when one of the tasks scheduled to use the peripheral device is started,
the power consumption managing unit issues a request to the clock supply control circuit so as to start supplying the clock signal at the determined supply start timing, and
the power consumption managing unit further controls to continue supplying of the clock signal so long as any one of the semaphores is acquired even if a task switching occurs, and issues a request of stopping supply of the clock signal when a task switching occurs after the semaphore is released.

4. The system according to claim 1, wherein the clock supply control circuit has a plurality of clock supply controllers corresponding to the peripheral devices respectively.

5. A system of controlling power consumption of a semiconductor integrated circuit, the system being provided with a plurality of peripheral devices, a clock supply control circuit to control supply of a clock signal to the peripheral devices, and a power supply control circuit to control supply of power to at least one of the peripheral devices whose receipt of power supply is to be controlled, wherein execution of a plurality of tasks for the peripheral devices is controlled by an operating system,
the operating system comprising:
a task information registration unit to register peripheral device use information for each of the tasks, the peripheral device use information indicating use or non-use of the peripheral devices as task information,;
a dispatcher to control start of any one of the tasks when an execution request of the task is received, and to control switching of task execution among the tasks,
a semaphore managing unit to manage state of acquisition and store semaphores indicating acquisition states of acquiring rights to use the peripheral devices in the tasks, respectively,
a power consumption managing unit to control the clock supply control circuit and the power supply control circuit, and
a management table registration unit to register a management table showing whether start of supplying the clock signal to at least one of the peripheral devices and start of supplying a power to one of the peripheral devices are executed when a task switching is performed or when the a semaphore acquisition is performed,
wherein the power consumption managing unit refers to the peripheral device use information, the management table and the semaphores, and issues a request to the clock supply control circuit so as to supply or stop the clock signal , in accordance with execution states of the tasks.

6. The system according to claim 5, wherein
the power consumption managing unit determines a timing of start of supply of the clock signal to one of the peripheral devices corresponding to one of the semaphores under release and determines a timing of start of power supply in the case where receipt of power supply of the peripheral device is to be controlled, respectively, with reference to the management table, when one of the tasks scheduled to use the peripheral device is started,
the power consumption managing unit issues a request to the clock supply control circuit so as to start supply of the clock signal to the peripheral device at the determined timing of starting the supply of the clock signal,
the power consumption managing unit issues a request of continuing the supply of the clock signal so long as the semaphore is acquired even if a task switching occurs,
the power consumption managing unit issues a request of stopping the supply of the clock signal when a task switching occurs after the semaphore is released,
the power consumption managing unit issues a request to the power supply control so as to start power supply at the determined power supply start timing, in the case where receipt of power supply of the peripheral device is to be controlled,
the power consumption managing unit controls to continue supplying of the power so far as the semaphore is acquired even if a task switching occurs, and
the power consumption managing unit issues a request of stopping the supply of the power when the task switching occurs after the semaphore is released.

7. The system according to claim 5, wherein the power supply control circuit have a plurality of power supply control units corresponding to the plurality of peripheral devices respectively.

8. The system according to claim 7, wherein the clock supply control circuit has a plurality of clock supply controllers corresponding to the peripheral devices respectively.

9. A system of controlling a power consumption of a semiconductor integrated circuit, the system being provided with a plurality of peripheral devices and a clock supply control circuit to control supply of a clock signal to the peripheral devices, the control of the clock supply control circuit being performed by a manger task which receives a use request for the peripheral devices from a plurality of tasks,
wherein the manager task has a queue and a peripheral device use information registration unit to register peripheral device use information, the queue receives a use request for using at least one of the peripheral devices from at least one of the tasks to control use orders of the at least one of the peripheral devices,
the manager task updates the peripheral device use information showing a use schedule of the at least one of the peripheral device at the timing of queuing or dequeuing from the tasks, and
the manager task issues a request to the clock supply control circuit so as to supply or stop the clock signal to the at least one of the peripheral devices based on the peripheral device use information.

10. The system according to claim 9, wherein the manger task issues a request to the clock supply control circuit so as to supply the clock signal to the at least one of the peripheral devices when the peripheral device use information shows presence of a use schedule, and the manger task further issues are request to the clock supply control circuit so as to stop the clock signal to the at least one of the peripheral devices when the peripheral device use information shows absence of a use schedule.

11. The system according to claim 9, wherein the clock supply control circuit has a plurality of clock supply controllers corresponding to the peripheral devices respectively.
